(19) United States
(12) Patent Application Publication
(10) Pub. No.: US 2022/0075949 A1
(43) Pub. Date: Mar. 10, 2022

(54) Association Determination

(71) Applicant: Dennis Mark Germishuys, Irene (ZA)

(72) Inventor: Dennis Mark Germishuys, Irene (ZA)

(21) Appl. No.: 17/416,737

(22) PCT Filed: Dec. 19, 2019
(86) PCT No.: PCT/IB2019/061077

§ 371 Date: Jun. 21, 2021

(30) Foreign Application Priority Data
Dec. 20, 2018 (ZA) 2018/08588

(51) Int. Cl. G06F 40/295; G06F 16/248

(52) U.S. Cl. CPC G06F 40/295; G06F 16/248

(57) ABSTRACT

An association system including hardware including at least one processor, a data storage facility in communication with the processor and I/O interfaces in communication with the processor, the system being configured to receive a name of a person/entity of interest via an input interface; retrieve top keywords associated with the name of the person/entity of interest from a database of Internet data and represent the keywords by word embedding; compare the top keywords with a list of keywords for which the relevance of the person/entity of interest is to be determined; determine the inner product between each of the retained top keywords and the word embedding of the name of the person/entity of interest; and present the inner product of each of the retained top keywords at an output interface of the association system.

### CROSS-REFERENCE TO RELATED APPLICATIONS

This application is the United States national phase of International Application No. PCT/IB2019/061077 filed Dec. 19, 2019, and claims priority to South African Patent Application No. 2018/08588 filed Dec. 20, 2018, the disclosures of which are hereby incorporated by reference in their entirety.

### BACKGROUND OF THE INVENTION

### Field of the Invention

The present invention relates to association determination. In particular, the invention relates to a system for determining an association of a person/entity of interest with pre-defined keywords and to a method of determining an association of a person/entity of interest with pre-defined keywords.

### Description of Related Art

The inventor identified a need to determine an association of an entity of interest with pre-defined keywords. The inventor is aware of known Internet searching techniques when searching for profiles of persons and/or entities on the Internet. Known Internet searching techniques provide results of persons and entities from search engines, social media sites, open source databases, and the like. However, it is often difficult to obtain an objective overview of a person/entity's profile profiles on social media sites as such profiles are created by a person/entity themselves and can therefore not be independently verified. Furthermore, such data is not always updated regularly.

It is an object of the present invention to provide a searching technique and system that will provide an association of a person/entity in relation to predefined keywords.

### SUMMARY OF THE INVENTION

According to a first aspect of the invention, there is provided an association system comprising hardware including at least one processor, a data storage facility in communication with the processor and input/output interfaces in communication with the processor, the system being configured to

receive a name of a person/entity of interest via an input interface;

retrieve top keywords associated with the name of the person/entity of interest from a database of Internet data and to represent the keywords by word embedding;

compare the top keywords with a list of keywords for which the relevance of the person/entity of interest is to be determined;

retain from the top keywords only those which appear in the list of keywords for which the relevance of the person/entity of interest should be determined;

determine the inner product between each of the retained top keywords and the word embedding of the name of the person/entity of interest; and

present the inner product of each of the retained top keywords at an output interface of the association system.

According to a second aspect of the invention, there is provided a method of determining an association of an entity of interest with pre-defined keywords, the method employed on an association system comprising hardware including at least one processor, a data storage facility in communication with the processor and input/output interfaces in communication with the processor, the method including the steps of

receiving a name of a person/entity of interest via an input interface;

retrieving top keywords associated with the name of the person/entity of interest from a database of Internet data and representing the keywords by word embedding;

comparing the top keywords with a list of keywords for which the relevance of the person/entity of interest is to be determined;

retaining from the top keywords only those which appear in the list of keywords for which the relevance of the person/entity of interest should be determined;

determining the inner product between each of the retained top keywords and the word embedding of the name of the person/entity of interest; and

presenting the inner product of each of the retained top keywords at an output interface of the association system.

The method may include the prior step of mining Internet data for occurrences in which the name of the person/entity of interest appear and storing the data in the database of Internet data.

The step of mining Internet data may include employing Natural Language Processing (NLP) tasks on unstructured data retrieved from the Internet.

The Natural Language Processing (NLP) tasks may include Named Entity Recognition (NER) Bigrams, and the like.

The method may include the step of translating the Internet data before storing the data in the database.

The method may include the prior step of receiving a list of keywords for which the relevance of the person/entity of interest should be determined.

The method may include the prior step of training the word embedding on selected text data.

The method may include the prior step of pre-determined word embeddings.

The invention is now described, by way of non-limiting example, with reference to the accompanying figure(s).

### BRIEF DESCRIPTION OF THE DRAWINGS

In the figure(s):

FIG. 1 shows an output in tabular form of an association system in accordance with one aspect of the invention, in which a particular person's/entity's association with predefined keywords are displayed;

FIGS. 2, 3 and 4 show a graphical representation of the output of FIG. 1;

FIGS. 5 and 6 show flow diagram of a method of determining an association of an entity of interest with pre-defined keywords in accordance with another aspect of the invention;

FIGS. 7, 8 and 9 show block diagrams of the association system of FIG. 1;

FIG. 10 shows an association system in accordance with the invention being connected to the Internet; and

FIG. 11 shows the hardware implementation details of the association system of FIG. 10.

### DESCRIPTION OF THE INVENTION

In the example shown in the specification, names of individuals were selected and certain keywords were selected against which the names had to be tested. The keywords were selected to fall in two categories namely a crime category and an anti-crime category.

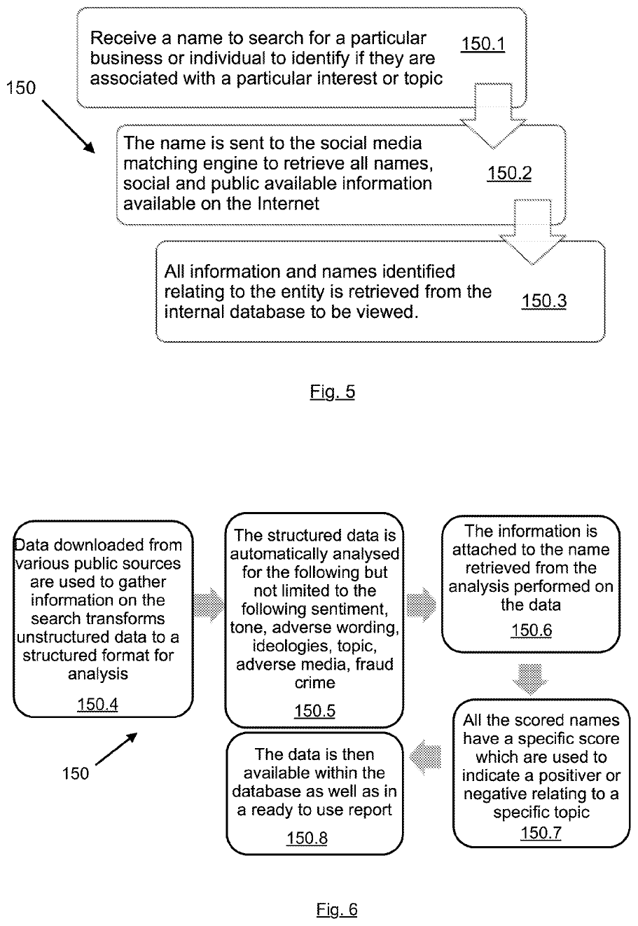

In FIG. 1, the output (100) of the method described in FIGS. 5 and 6 are shown in tabular form with the column (106) containing the names of individuals. Column (102) contains anti-crime keywords and column (104) contains crime keywords. Column (108) indicates a score of the name in relation to the keyword associated with anti-crime and column (110) indicates a score of the name in relation to the keyword associated with crime. Column (112) is a binary representation which indicates whether the name of the person is related more with crime (indicated by a ‘1’) or more with anti-crime (indicated by a ‘0’).

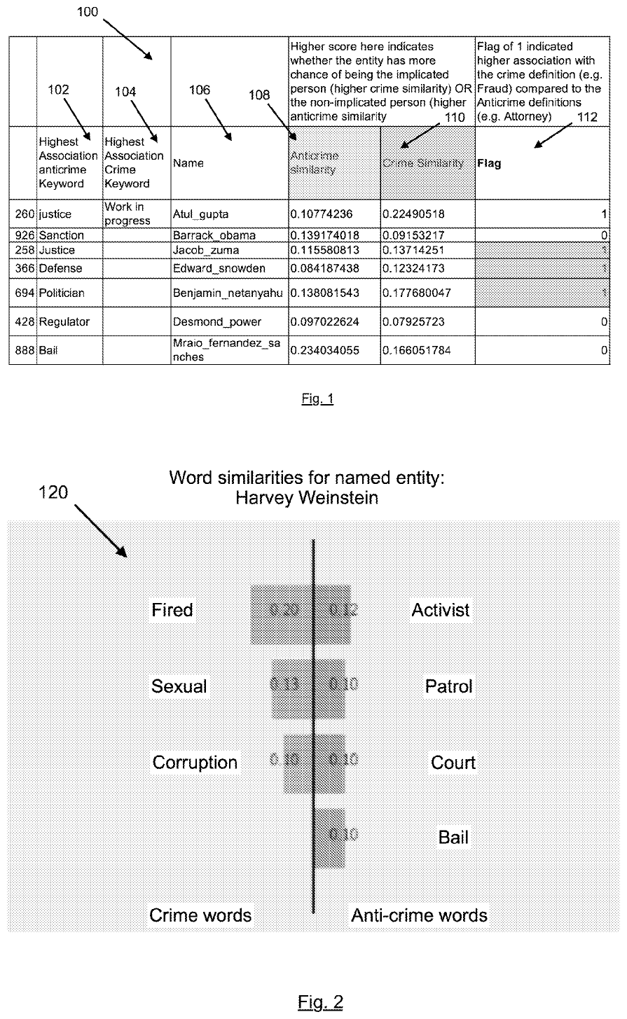

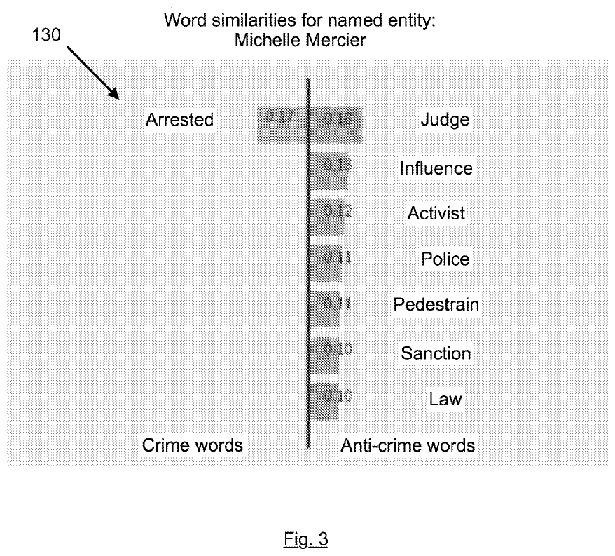

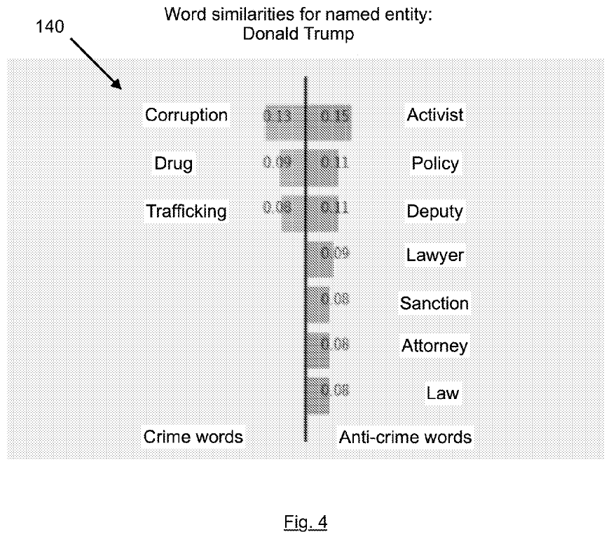

FIGS. 2, 3 and 4 show graphical representations of the names of Harvey Weinstein (120), Michelle Mercier (130) and Donald Trump (140) and their association with keywords related to crime (shown to the left) and of keywords related to anti-crime (shown to the right). As can be seen in the figures, each word has a score associated with it, indicating the association of the keyword with the name of the person. The score is the inner product between the keyword and the name of the person/entity of interest.

FIGS. 5 and 6 show flow diagrams of a method (150) of determining an association of an entity of interest with pre-defined keywords.

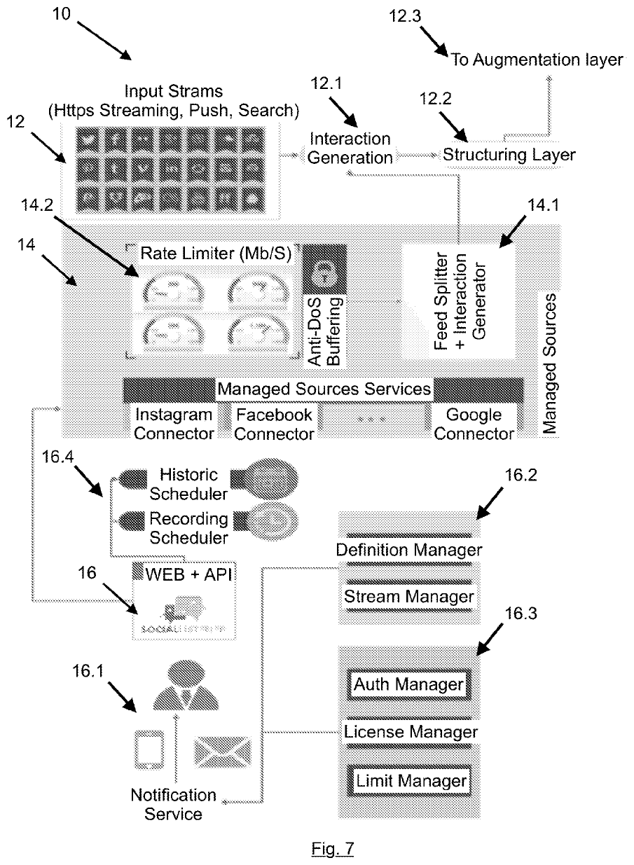

In FIG. 5, the method (150) is initiated at (150.1) by receiving a name of a person/entity and to receive a list of keywords against which the name should be tested. At (150.2) the name of the person/entity is send to the association system shown in FIGS. 7, 8 and 9 to retrieve all information of the person/entity that is available on the Internet from social media sources and other open source databases. At (150.3) all the information in the name of the person/entity is retrieved.

In FIG. 6, the method proceeds at (150.4) by structuring the data that is available from the unstructured data sources for further analysis. This step includes determining the words embedding of the keywords and or phrases in which the keywords occur. The name of the person/entity is analysed against certain predefined keywords at (150.5) and (150.6). Each of the keywords is scored in terms of its prominence in relation to the name of the person/entity at (150.7). The “scoring” of the keywords are done by taking the inner product of the keywords and the name of the person/entity of interest. At (150.8) the data is made available in the format shown in FIGS. 1 to 4.

FIGS. 7, 8 and 9 show an association system (10) in accordance with the invention.

As can be seen in FIG. 7, the system (10) is connected onto the Internet to receive input streams from a plurality of social media sources at (12). Social media connectors (14) are operated to interface with social media platforms to receive the required data from the social media platforms, such as Pinterest, Twitter, Facebook, LinkedIn, Google+, and the like. All the available unstructured and structured data feeds are collected for example from media, news, blogs, social media and online data streams. A social listener is scheduled to run and to receive new feeds from the various social media and other platforms.

At 12.1 an interaction generation process is executed where the queries are created automatically by the system to extract specific content from the input streams without a requirement for human interaction to enter a specific search criteria or search objective. At 12.2 a structuring layer transforms unstructured data to structured data in, for example, a relational database. At 12.3 an augmentation layer appends new and additional data to the existing database. At 16.4 an interaction generator uses client specific requests programmed into an historic scheduler and a recording scheduler to extract relevant content from the unstructured data.

At 14 a managed sources function is performed. This function entails the management of services performed for an individual client for whom this method is performed. At 14.1 a feed splitter handles the extraction of data from the different input streams as defined in the interaction generation process of 12.1. At 14.2 a rate limiter applies predefined bandwidth allocations to individual clients.

At 16 a web interface and application programming interface is provided to communicate with individual clients. At 16.1 a notification service is executed which transmits messages to individual clients via email of SMS if predefined content of interest has been detected in the data.

At 16.2 a definition manager and a stream manager is pre-programmed to adhere to rules and regulations pertaining to specific media and content providers. Notifications generated by the definition manager and a stream manager 16.2 are forwarded to clients.

At 16.3 an Authorisation manager, License manager and limit manager controls access, modules, data and any limitations set on licenses from particular data stream sources.

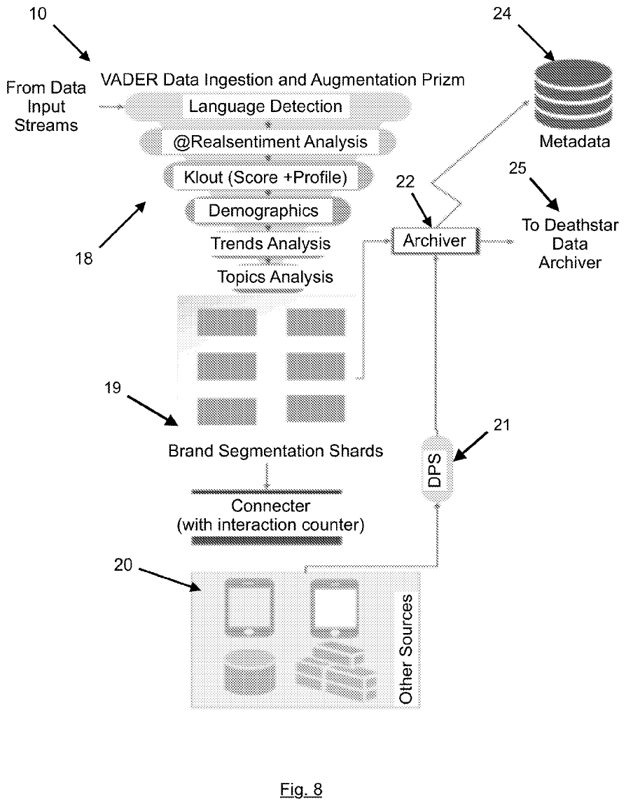

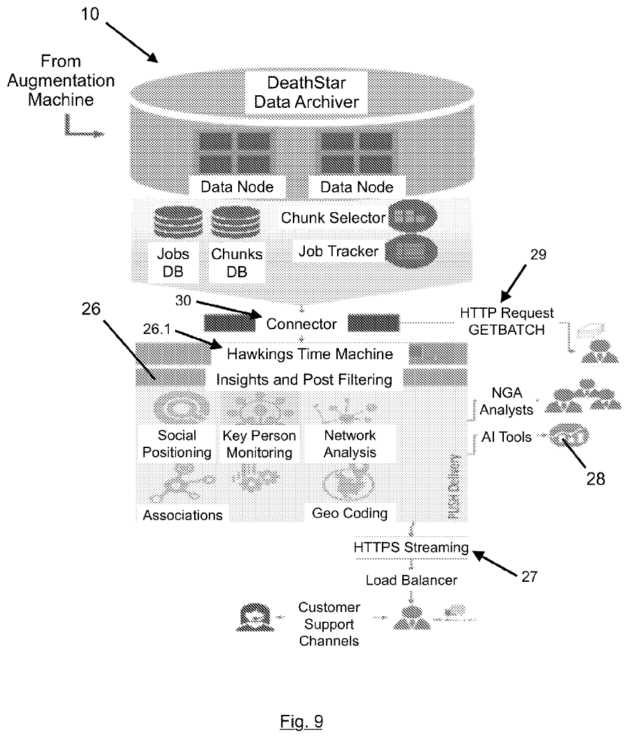

In FIG. 8, the input streams obtained from the various social media sources are analysed at (18) by proprietary software referred to as VADER, which is presented as a data ingestion and augmentation prism. The prism consists of various layers of Natural Language Processing (NLP) algorithms which are applied to identify insights in the unstructured data. Additional layers can be added depending on the outcome required. The NLP algorithms may typically include layers such as RealSentiment which is used to extract information of the person/entity in terms of topics that are raised, trends in the data feed, demographic information, its social media influence in terms of a Klout score, and the like.

Other information sources, such as open source databases are accessed at (20) and is passed through a Data Processing System (DPS) at (21) where it is appended to primary input streams. The data is combined at (22) and stored in a database at (24).

At (25) the data is made accessible to a so called Deathstar Arthiver (10).

At 19, brand segmentation shards are used to segment and group data according to various predefined associations.

From the brand segmentation shards 19, data is sent to an archiver where it is stored for processing and future use. This data now includes metadata. The brand segmentation shards provides an output to a connector with an interaction counter which limit client accounts based on the type of license with the provider of the method.

In FIG. 9 further processing of the archived data at 22 and 25 in FIG. 8 done. Data is archived on the so-called Death Star Data archiver (10). Data is segmented and stored with metadata in the archiver (10). Data is segmented in terms of a person/entity's social media positioning, key persons involved in the entity, network analysis of the person/entity, associations that the person/entity belongs to, and geographic information of the person/entity.

At (26) visualization tools are used to view and analyse the data. The data is accessed via a so-called connector (31) through which the data in die archiver (10) is viewed/accessed. At (26.1) the data is dated and timestamped by a so called Hawkings time machine to enable activity based analysis of the data over a period of time.

The visualisation tools include indications of social positioning of a person/entity, key person monitoring, network analysis, associations of persons, geo location of activities, and the like.

At (27) a presentation layer presents a dashboard of insights to clients via HTTPS streaming. At (29) following an HTTP request, information is batched for clients requesting batched information.

At (28) data is forwarded to a Business Intelligence tool for further reporting via an output interface to a client.

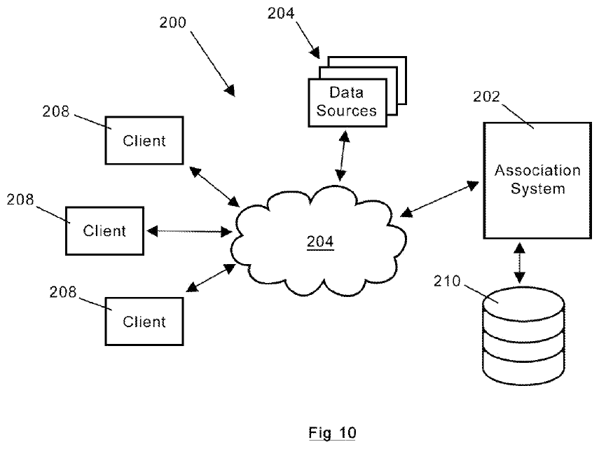

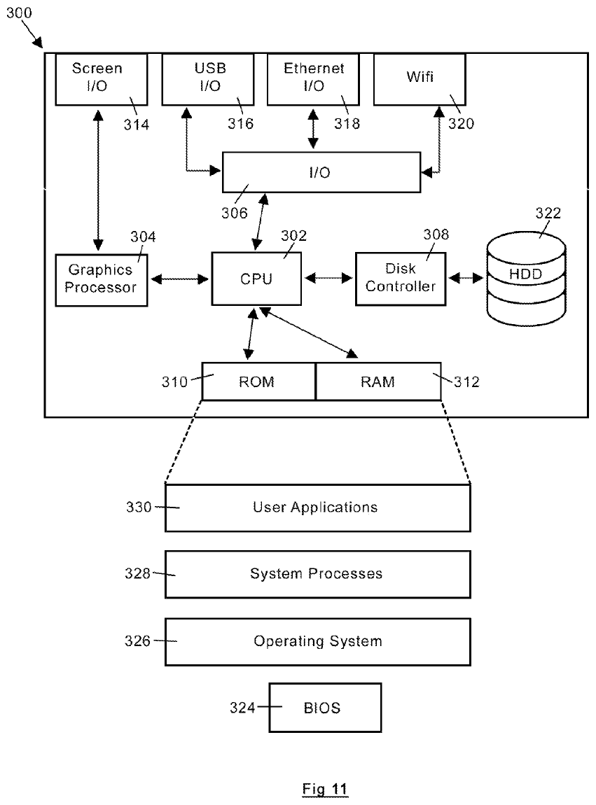

In FIGS. 10 and 11, the hardware implementation of the method described above will be described.

In FIG. 10, reference numeral (200) refers to an example of an association system in use. The association system (202) is connected to the Internet (204), which is in turn connected to a multitude of data sources (204). These data sources (204) include social media platforms, news sites, web pages and any other data that is publicly available on the Internet. These data sources are crawled/scraped in the normal manner to collect data from them. This data collection is performed periodically or continuously to collect as much data as is possible on the system.

The association system (202) collects the data (204), process it as described above and store the information in a database (210).

The output of this data is then presented to clients (208) via an output interface, such as an HTTPS (27) or API (16) front-end, as described above. Alternatively, as also described above, the data can be made available in batches (29). Clients (205), who are connected to the Internet has access to the data via the Internet (204).

In FIG. 11, an example of a hardware implementation of the system on a computer (300) is shown. The computer (300) comprises a central processing unit (CPU) (302), which is connected via a bus architecture to a graphics processor (304), an Input/Output controller (306), a disk controller (308) and memory in the form of Read Only Memory (310) and Random Access Memory (312).

The CPU is operable to execute an application embodying the method to be performed.

The graphics processor (304) is connected to a screen Input/Output controller. The Input/Output controller (306) is connected to a USB Input/Output (316), to an Ethernet Input/Output (318) and to a WiFi Input/Output (320). It is to be appreciated that the Input/Output controller (306) can be connected to a multitude of other Input/Output devices, not shown in this example. The Disk controller (308) is connected to a Hard Disk Drive (322).

When in use, the ROM/RAM (310)(320) in combination with the CPU (302) executes a Basic Input/Output system, an operating system (326), system processes (328) and user applications (330), of which the association system implementing the method of determining an association of an entity of interest is one.

The Input/Output controller (306) may employ different communication protocols such as audio, analog, IEEE-1394, universal serial bus (USB), infrared, digital video interface, IEEE 802.n/b/g/n, Ethernet (various), Bluetooth, and the like. In this example, the Association system (202), is connected to the internet via an Ethernet port (318).

The Disk controller (308) typically employ connection protocols such as Serial Advanced Technology Attachment (SATA) protocol, Integrated Drive Electronics (IDE) protocols, or the like.

The operating system (326) can be any operating system, such as a Mac OS, Unix, Linux, Microsoft, or the like.

The HDD (322) will store executable instructions to implement the system described FIGS. 7, 8 and 9 to perform the method described in FIGS. 5 and 6.

Importantly, the technical effect performed by the system relates to transforming Internet data that is publicly available, or available from other data sources into an output that can be represented as the inner product of names and keywords that are pre-programmed into the system and a resultant 0 or 1 flag (as indicated in FIG. 1) that can be presented to a user via the Input/Output controller (306) and its associated outputs being a USB Input/Output (316), an Ethernet Input/Output (318) and a WiFi Input/Output (320).

The inventor is of the opinion that the invention, as described provides a new system for determining an association of an entity of interest with pre-defined keywords and a new method of determining an association of an entity of interest with pre-defined keywords.

1. An association system comprising hardware including at least one processor, a data storage facility in communication with the processor and input/output interfaces in communication with the processor, the system being configured to
receive a name of a person/entity of interest via an input interface;
retrieve top keywords associated with the name of the person/entity of interest from a database of Internet data and to represent the keywords by word embedding;
compare the top keywords with a list of keywords for which the relevance of the person/entity of interest is to be determined;
retain from the top keywords only those which appear in the list of keywords for which the relevance of the person/entity of interest should be determined;
determine the inner product between each of the retained top keywords and the word embedding of the name of the person/entity of interest; and
present the inner product of each of the retained top keywords at an output interface of the association system.

2. A method of determining an association of an entity of interest with pre-defined keywords, the method employed on an association system comprising hardware including at least one processor, a data storage facility in communication with the processor and input/output interfaces in communication with the processor, the method including the steps of
receiving a name of a person/entity of interest via an input interface;
retrieving top keywords associated with the name of the person/entity of interest from a database of Internet data and representing the keywords by word embedding;
comparing the top keywords with a list of keywords for which the relevance of the person/entity of interest is to be determined;
retaining from the top keywords only those which appear in the list of keywords for which the relevance of the person/entity of interest should be determined;
determining the inner product between each of the retained top keywords and the word embedding of the name of the person/entity of interest; and
presenting the inner product of each of the retained top keywords at an output interface of the association system.

3. The method of claim 2, which comprises the prior step of mining Internet data for occurrences in which the name of the person/entity of interest appear and storing the data in the database of Internet data.

4. The method of claim 3, in which the step of mining Internet data comprises employing Natural Language Processing (NLP) tasks on unstructured data retrieved from the Internet.

5. The method of claim 4, in which the Natural Language Processing (NLP) tasks comprises Named Entity Recognition (NER) Bigrams.

6. The method of claim 5, which comprises the step of translating the Internet data before storing the data in the database.

7. The method of claim 6, which comprises the prior step of receiving a list of keywords for which the relevance of the person/entity of interest should be determined.

8. The method of claim 2, which comprises the prior step of training the word embedding on selected text data.

9. The method of claim 2, which comprises the prior step of pre-determined word embeddings.
